(19) United States
(12) Patent Application Publication
(10) Pub. No.: US 2008/0265222 A1
(43) Pub. Date: Oct. 30, 2008

(54) Cellulose-Containing Filling Material for Paper, Tissue, or Cardboard Products, Method for the Production Thereof, Paper, Tissue, or Carboard Product Containing Such a Filling Material, or Dry Mixture Used Therefor

(76) Inventors: Alex Ozersky, Richmond Hill (CA); Ralf Recknagel, Rosenberg (DE); Hans-Georg Brendle, Ellwangen (DE)

Correspondence Address: FAY SHARPE LLP, 1100 SUPERIOR AVENUE, SEVENTH FLOOR, CLEVELAND, OH, 44114, US

(21) Appl. No.: 11/666,934

(22) PCT Filed: Nov. 3, 2005
(86) PCT No.: PCT/EP05/11758

§ 371 Date: Jun. 27, 2008

(30) Foreign Application Priority Data
Nov. 3, 2004 (DE) 10 2004 053 654.6

(51) Int. Cl. C09C 1/02; C09D 101/02; C09C 1/04; C09C 1/36; C09C 1/44; H01B 1/00; C09K 21/00; C08L 1/08; C09C 1/30; C09C 1/28

(52) U.S. Cl. 252/607; 106/501.1; 106/420; 106/447; 106/491; 106/487; 106/500; 524/35; 524/36; 106/419; 106/469; 106/465; 106/471; 252/500

(57) ABSTRACT

Multifunctional surface-modified cellulose-containing fibers, especially for producing paper and cardboard packagings, are provided with numerous specific advantages regarding production and the product. The invention particularly relates to cellulose compounds and microcomposites in which solid materials, liquids, and dispersed or amorphous additives, for example, are coated onto the surface of the cellulose, and methods for the production of said compounds.

### TECHNICAL FIELD

The invention concerns a cellulose-containing filler for paper, tissue or cardboard products, as well as manufacturing methods for this, and paper, tissue or cardboard product containing such a filler, or the dry mixture used for this, according to the preamble of patent claims 1, 39, 52 and 38, respectively.

### TECHNICAL BACKGROUND

For thousands of years, the basic substance for production of paper and cardboard has been cellulose fibers, obtained from various plant raw materials. At present, cellulose fibers obtained from wood are used almost exclusively. What is common to them all is that they are long-stapled products made in a wet grinding process. Thanks to the large fiber length, one achieves a good interlocking in the paper and cardboard, leading to the formation of a sheet and being of utmost importance to the mechanical strength. These long-stapled products are the basis of paper and cardboard production; without them, no paper or cardboard could be produced. Their interlocking results in the necessary sheet formation. They can differ in degree of purity, as well as in fiber structure (grinding degree ° SR). There is highly purified, lignin-free cellulose, as well as lignin-containing fibers (wood chips, CTMP) and recycling fibers, obtained from scrap paper and accordingly still having various impurities.

Finely divided products, such as native starch, calcium carbonate, kaolin or titanium dioxide are used for various reasons in the production process of cardboard and paper plants. Due to their small particle size, these products are very easily washed out from the paper web. It takes additional measures to achieve at least a certain degree of retention in the paper web. But this involves higher costs, as well as other technological disadvantages. According to the literature data, at present one often finds less than 40% degree of retention of fillers and pigments on high-speed paper machines (>1500 m/min), despite polymer retention agents.

In addition to the above-mentioned relatively long cellulose fibers, special cellulose fibers usually broken up by dry or moist grinding technologies are used as additives in the making of pasteboard and paper from fiber pulp, in order to achieve higher volume or lower paper weight, a better formation, and a faster drainage. These fibers have a distinctly shorter fiber length than the above-described sheet-forming cellulose fibers. They are added in a fraction of less than 10%. Their task is to influence the sheet formation of the long cellulose fibers so that the above-mentioned effects can be achieved. The drawback with them is the negative influencing of the mechanical strength values and, in the case of lignin-containing additives, a worsening of the whiteness of the finished product.

### THE INVENTION

To lessen the consumption of additives and possibly reduce the additive-related need for treatment of the water accruing during the production of paper, tissue or cardboard products, a filler with the features of claim 1, a method for its production with the features of claim 39, a corresponding paper, tissue or cardboard product per claim 52, and a dry mixture per claim 38 are proposed. Preferred embodiments and applications are find in the subclaims.

Thanks to the invention, additives for paper, tissue or cardboard production are bound to the cellulose component of the filler, so that they remain clinging to the fibers to a substantial degree even in aqueous suspensions. One can also use liquid substrates, such as wet-strength agents or optical brighteners, which are part of paper-making recipes in any case. Since these fibers are coarse enough to remain in the paper web without additional expense, the finely particulate components clinging to the surface are also retained in the paper web.

In terms of the dosage of powderlike pigment and filler, the new development of the invention provides a better retention on the sheet former. Thanks to the fixation, the amount of costly additives used is reduced and furthermore the waste water burden is decreased. What is more, expensive processes such as starch cooking or the surface sizing press are replaced by simpler processes in the paper plant.

Whereas the “fiber loading” method requires a pretreatment with liquid calcium hydroxide and a reaction with gaseous carbon dioxide, the new development according to the invention furnishes stable coatings with simple mechanical methods.

Thus, a multifunctional filler having at least one additive is proposed, which can offer the following benefits, among others:

1. Increases the drainage and productivity

2. Improves the rheological properties (as compared to lignin)

3. Improves the formation

4. Reduces the drying costs

5. Enhanced dimensional stability

6. Higher volume

7. Increased filler retention, less consumption of retention agent in the individual case

8. Improved sizing for hydrophobicity and oleophobicity

9. Increased whiteness and better printability (compared to lignin)

10. Higher opacity

11. Higher strength

12. Better action of the optical brightener in the coating and better printability

13. Biocidal finish

14. Flame retardation

15. Antistatic properties

16. Cationization and adjustment of the zeta potential

17. Greater affinity for inks

18. Higher solid content

19. Reduced quality fluctuations in the case of recycled paper

Insofar as the invented filler has cellulose, lignocellulose, or microcrystalline cellulose (i.e., a cellulose component), this shall also be understood to include cellulose-containing precursors or intermediates that also contain other plant ingredients, such as albumen, protein, starch, and/or mineral components and other things. Thus, it is not absolutely necessary to carry out an excessive chemical treatment of the plant raw material. Instead, plant ingredients can be contained in the cellulose component, while their overall proportion should not be more than 25% of the cellulose component.

The particle size of the cellulose component is preferably restricted to not more than 1 mm particle size, preferably not more than 0.5 mm particle size, while there is no restriction in the direction of smaller particle sizes, since even particle sizes in the nano-region can be used successfully.

When the additive is used in particulate form, the particle sizes are preferably not more than 0.1 mm, preferably not more than 0.05 mm. Here, again, a limiting of the particle size at the bottom end is not necessary. Rather, it should be noted that the particle size of the additive used is generally smaller, preferably much smaller than the particle size of the cellulose component.

The mass ratio between the cellulose component and the additive component is preferably not less than 1 to 10 and especially preferably not less than 2 to 10. No limitation is required in the direction of larger mass ratios, since very small amounts of additive may be enough, in certain circumstances, to achieve the desired effect in the paper, tissue or cardboard production. Otherwise, it is also possible to apply the additive in several layers onto the particles of the cellulose component. This makes it possible to achieve very small mass ratios of cellulose component to additive component.

Additives, as shall be presented in detail hereafter, can be more than just pure additives. Instead, the raw materials containing the additive can be brought into the production process of the invented filler so that the preparation of the raw materials and the fixing or coating of the additives on the particles of the cellulose component takes place in a single work step. Thus, for example, one can use starch-containing raw materials, such as soft wheat grass, oat bran fractions, as well as extruded or baked pregelatinized starches, so as to increase the strength of the paper or cardboard, on the one hand, or to improve the internal cohesion between fiber and coating substrate, on the other hand, as well as lessen the “dusting out” from the paper. Furthermore, nanodispersed celluloses can be used, such as those based on microcrystalline cellulose, in order to provide a substrate for coatings, such as optical brighteners, and at least partly replace additives such as polyvinyl alcohol, spray starch, and CMC, and improve the printability.

With the invention, a number of fillers with different effect can be realized for the paper, tissue or cardboard production. The preferred embodiments shall be described hereafter:

The following fillers have the shared notion of using cellulose fibers, especially those of the applicant, as a substrate for traditional paper-making additives, in order to enhance the effectiveness of the additives, reduce their consumption, and decrease the CSB load in the waste water:

1) A novel sizing compound, which consists of fibers and a sizing complex, that improves the hydrophobicity and/or the oleophobicity of the paper and cardboard, the uniformity and durability of the sizing, and the retention of the sizing agent during sheet formation. A further object of the invention is a production process for sizing compounds. Use of the sizing compound provides an improved price/performance ratio for the sizing.

2) A novel mineral compound, which consists of fibers and minerals (fillers, pigments). Whiteness and light-fastness of the fibers used are substantially improved by the surface modification, so that it also becomes possible to use it in very bright cardboard and paper.

One object of the invention is a light filler, consisting of fibers and mineral, for the fabrication of paper and cardboard. The light filler can increase the volume of the paper, the machine speed, and the filler retention.

3) A novel starch compound, which consists of fibers and native or cationic starch and can enhance the strength values (Mullen strength, ply bond layer strength, tear index, tensile index, tearing length, etc.) for identical substance weight or which allows one to decrease the substance weight without losses of strength. Its use would be preferred, though not exclusively, in the wet end region. The starch on the fiber can be partly pregelatinized or be homogenized with the fiber, or it can consist of starch mixtures. Modifying the fiber with starch results in an improvement of the mechanical strength indices of the fiber network in the end product. One object of the invention is a better retention of the starch in paper and cardboard, especially in the case of recycling papers with high anionic load and high mineral fraction, in order to provide a higher strength to the paper and cardboard. Another object of the invention is the fabrication of a new type of strength-boosting additive, wherein fibers are pregelatinized or reacted with starch in the high consistency range or in the dry state.

4) A novel biocide compound, which consists of fibers and a biocide complex. The biocide can be immobilized on the surface of the fibers. The biocide compound can be used, for example, in the wet end region for corrugated cardboard raw paper and for gypsum fiberboard.

5) A novel brightening compound, which consists of fibers or microcrystalline colloidal cellulose and can contain an optical brightener. The brightener can be immobilized on the surface of the fiber or in a cellulose gel. The fiber can be bleached in presence of the usual bleaching agents, such as hydrogen peroxide, oxygen, or ozone. The coating, furthermore, can contain powderlike or liquid brighteners, such as are described as optical brighteners for lignocellulose.

6) A novel antistatic compound, which consists of fibers and an electrically diverting, antistatic additive. The antistatic additive can be immobilized on the surface of the fiber.

7) A novel cationic fiber compound, which consists of fibers and a cationization agent and is serves to adjust the zeta potential of cardboard and paper.

8) A novel flame-retardant fiber compound, which consists of fibers and a flame retardant agent and serves to adjust the flame retardation of cardboard and paper.

9) A novel liquid resin fiber compound, which consists of fibers and a liquid resin or a gel and serves to adjust the strength of cardboard and paper.

### SAMPLE EMBODIMENT 1

### Sizing Compound

Laboratory sheets of 6.00 g at 35° SR and a concentration of 6 g/4 liters were produced. The laboratory sheets were dried in a drying cabinet at 125° C. for 2 hours and conditioned at room temperature for 4 hours. The drop test was performed as a fast test with 75% formic acid. An improved sizing outcome is definitely noted, especially when tested with the Emtec penetration test device and for the Cobb 300 value.

| | | AKD | C100- | C 100- | C 100- |
|---|---|---|---|---|---|
| | | resin | 33 | 46 | 67 |
| | | compar- | AKD | AKD | AKD |
| Specimen | | ison | J | J | WM |
| AKD quantity | % | 3 | 3 | 3 | 3 |
| Weight gain | g/12 g | 0.36 | 1.20 | 0.93 | 0.57 |
| Drop test front | sec | 244 | 126 | | 1593 |
| side | | | | | |
| Drop test back side | sec | 285 | 175 | | 2308 |
| Cobb 300 sec | g | 52.2 | 39.8 | 42.7 | 37.1 |

### SAMPLE EMBODIMENT 2

### Starch Compound

Fibers coated by means of rubbing were prepared from 50% wood fiber ARBOCEL C 100 and 50% native potato starch from the Aroostock Company and used to make laboratory sheets (157-158 g/m2 at 40° SR), using two different quantities. The iodometric starch test in the fibers proves the good retention of the starch in the paper web; additional retention agents were not needed. A dry blend of C 100 with native potato starch produces no significant starch retention on the sheet former.

| | | Measured | | | |
|---|---|---|---|---|---|
| | Absorp- | starch | Starch | Sub- | |
| | tion | content | reten- | stance | Moisture |
| | 580 nm | in paper | tion | weight | content |
| Compound | [% ISO] | [%] | [%] | [g/m²] | [%] |
| C100 - 50 | 41.87 | 0.87 | 87 | 158 | 7.3 |
| NFS | | | | | |
| C100 - 50 | 62.83 | 1.60 | 78 | 157 | 8.1 |
| NFS | | | | | |

### SAMPLE EMBODIMENT 3

### Starch Compound

The stock flow was OCC Furnish 60°, gray fibers, substance weight 200 g/mm², grinding degree 31° SR. Laboratory sheets were made with 6 g per 4 liters on Rapid Kothen sheet former and tested for the Mullen bursting index after drying and conditioning.

It turns out that the fiber-starch compound is of similar good quality to pregelatinized starch.

| | | Mullen bursting |
|---|---|---|
| | Substance weight | index |
| Recipe | g/sheet | kPa/g |
| Basic stock flow OCC - 60° | 5.88 | 2.08 |
| | 6.21 | 2.03 |
| +5% ARBOCEL C 100 | 6.69 | 2.00 |
| | 6.85 | 1.93 |
| +5% ARBOCEL C 100 | 6.77 | 1.84 |
| +5% EmCat C-FF (cat. potato | 6.55 | 2.07 |
| starch) | | |
| +5% ARBOCEL C 100 | 6.41 | 2.69 |
| +5% Pregel CPS Roquette CWS 45 | 6.54 | 2.68 |
| +10% C 100 - 50 CPS C | 6.86 | 2.52 |
| (Compound with 50% cat. potato | 6.71 | 2.56 |
| starch) | | |

### SAMPLE EMBODIMENT 4

### Starch Compound

The drainage performance in milliliters [ml] with the Dynamic Drainage Jar (Mytec) shows that the starch compounds can increase the drainage of the paper web and at the same time increase the strength after drying.

An AP substance (30° SR, ash 15%) at 2.00% dry matter was used, containing in turn 3-7% starch compound. The starch compound C 100-15 CS contains 15% cationic corn starch. The agitator velocity was 300 revolutions per minute on the SR screen.

| 2% AP slurry | | +additive C 100 - 15 CS | | | | no additive |
|---|---|---|---|---|---|---|
| Dosage | % | 3 | 5 | 7 | 10 | 0 |
| 5 sec | g | 166 | 168 | 175 | | 148 |
| 30 sec | g | 390 | 396 | 400 | | 350 |
| 60 sec | g | 519 | 524 | 530 | | 463 |

### SAMPLE EMBODIMENT 5.1

### Mineral Compound

Compound specimens were fractionated by means of a Retsch vibration screen for 5 minutes at 10 mm amplitude. The ash was determined in a muffle furnace for 4 hours at 850° C., whereupon the calcium carbonate was converted into calcium oxide; titanium dioxide remains unchanged during this incineration.

| | | Physical | | Physical | |
|---|---|---|---|---|---|
| | | dry | | dry | |
| | | blend | Compound | blend | Compound |
| | | # 1.1 | # 1.2 | # 1.3 | # 1.4 |
| Composition | | LIGNOCEL C | LIGNOCEL C | ARBOCEL C | ARBOCEL C |
| | | 120 + | 120 + | 750 + | 750 + |
| | | 40% CaCO₃ | 40% CaCO₃ | 50% CaCO₃ | 50% CaCO₃ |
| Mineral/ | | Hydrocarb | Hydrocarb | Omyacarb | Omyacarb |
| Pigment | | 10160 | 10160 | 2GU | 2GU |
| Bulk weight | g/L | 180 | 193 | 164 | 202 |
| Moisture | % | 9.5 | 9.4 | 3.6 | 3.6 |
| Ash content of | | | | | |
| screen fractions | | | | | |
| vibration screen: | | | | | |
| <32 μm | % TS | 32.3 | 20.2 | 21.3 | 4.9 |
| 32-50 μm | % TS | | 19.4 | | 31.2 |
| 50-90 μm | % TS | | 23.3 | | 48.0 |
| 90-150 μm | % TS | | 26.4 | | 11.2 |
| 150-200 μm | % TS | | 36.6 | | 4.0 |

Key: TS = dry substance

The high ash proportions in all fractions show that the mineral components are bound to a high degree on the surface of the fiber particles. In the case of a purely physical blending, mineral particles are primarily found in the fine fraction <32 μm.

### SAMPLE EMBODIMENT 5.2

### Mineral Compound

Various compounds were produced with inorganic fillers and pigments by means of Mullen mixer (MM) and by means of Nara Hybridizer (NH).

The titanium dioxide pigment used was a rutile pigment from Kronos with designation “Kronos 2050”. 20 grams of compound were agitated in a Waring Blender with 200 ml of water for 1 minute, then diluted to 2 liters of water and stirred by magnetic agitator for 5 minutes, then filtered through a 45 μm PP braided filter (air throughput 440 l/m2 min). The ash values were determined in the muffle furnace at 850° C.

| | | Ash before | Ash after | Filler |
|---|---|---|---|---|
| | | washing | washing | retention |
| Method | Compound | [%] | [%] | [%] |
| NH | BE 600/10 TG - 30 | 25.67 | 21.93 | 85.4 |
| | TiO2 | | | |
| NH | BE 600/30 PU - 30 | 27.78 | 18.02 | 64.9 |
| | TiO2 | | | |
| NH | BWW 40 - 25 TiO2 | 18.58 | 12.33 | 66.4 |
| MM | BWW 40 - 50 TiO2 | 49.56 | 36.05 | 72.7 |

### SAMPLE EMBODIMENT 6

### Brightener Compound

Optical brighteners from Ciba Pfersee were used to increase the whiteness of the cellulose fibers ARBOCEL BER 40. These components, in turn, are suitable in the mixture for the color brightening of cellulose and MCC, especially to reduce the b* value. The brightness values achieved allow the pulp to be reformulated in terms of “light fastness” and recipe costs.

| | Reflection at 440 nm | Whiteness at 460 nm |
|---|---|---|
| Mixture | [% ISO] | [% ISO] |
| BER 40 | | 86.2 |
| BER 40 + 0.1% | 105.4 | 101.2 |
| UVITEX BHT | | |
| BER 40 + 0.3% | 110.4 | 102.8 |
| UVITEX BHT | | |

### Working Methods

The degree of grinding was determined according to Schopper Riegler per ISO 5267/1. In certain cases, the degree of grinding for 35-750 ml drainage was counterchecked with the DDJ drainage measuring device, with 1000 ml for 60 seconds at 3.0% dry substance and 20° C. on 60 mesh ° SR screen. The filtrate [ml] after 60 seconds corresponds to the CSF value [ml].

Laboratory sheets with 100 cm2 were produced on a Rapid-Kothen sheet former per DIN 54358/ISO 5269/2. The bursting pressure for laboratory sheets of the same substance weight was determined as the Mullen Burst Index.

The whiteness [% ISO] was measured as the reflection at 460 nm by means of the Minolta color meter CM 3600, color values per CIE or Hunter.

The ash content was determined in the muffle furnace at 450° C. (after 5 h) or 850° C. (after 8 h). The starch content was determined by iodometric titration per Tappi T 419 om −91.

Cobb value was determined per ISO 535, EN 20535 and Tappi T441, and also with the Emtec penetration test device.

Drainage and retention were determined with Mytek Drainage Meter. During the drainage measurement, the fiber suspension was poured into the agitation chamber and, after adding the additive, subjected to a shearing action. During the measurement process, the suspension is filtered on a screen and the quantity of filtrate [is found] gravimetrically for the drainage time. Agitation speed 300 rpm at 2% dry substance corresponds to specimens in the cardboard range (gray range).

For the retention measurement, the fiber suspension under continual agitation—without building up a filter layer—is drained on a screen. By determining the solids content in the filtrate, or after drying and incineration, the total retention and the retention of filler can be calculated.

Various wood fiber substances were coated with very finely divided mineral additives, such as titanium dioxide or calcium carbonate, by frictional mechanical forces (average particle size of the minerals <10 μm). The fiber substances used included:

| | | Fiber | Degree | White- |
|---|---|---|---|---|
| | | length | of | ness |
| | | particle | grind- | [460 |
| | | size | ing | nm] |
| Fiber substance | Structure | μm | °SR | % ISO |
| LIGNOCEL C 120 | Lignocellulose | 120 | 11-12 | 54-57 |
| LIGNOCEL CB 120 | Lignocellulose | 120 | | 50-55 |
| ARBOCEL B 600 | Cellulose | 60 | | 86-90 |
| ARBOCEL C 100 | Lignocellulose | 100 | 10-11 | 55-56 |
| ARBOCEL C 750 | Lignocellulose | 80 | 14-16 | 58-60 |
| VIVAPUR 101 | Microcrystalline | 50 | | 85-91 |
| | cellulose | | | |
| ARBOCEL C 750 | Bleached | 80 | 16-18 | 70-73 |
| BRIGHT | Lignocellulose | | | |
| ARBOCEL CW 630 | Lignocellulose | 40 | | 60-61 |
| PU | | | | |
| ARBOCEL E 140 | | 120 | | 57-58 |

The following components were used:

Cationic potato starch Hi-CAT® CWS 42 (Roquette Germany)

Particle size up to 500 μm, moisture content 8%, nitrogen content under 2%

Cationic corn starch C* Bond HR 05946 and C* Bond HR 05947 (Cerestar Netherlands)

Particle size 8-25 μm, moisture content 10%, nitrogen content under [?]

Native potato starch (Roquette France/Beinheim)

Particle size 15-60 μm, moisture content 12%

Polyvinyl amine resin solution (BASF Germany)

Lupamine and Basocoll brands, with max. 9% nitrogen content

Calcium carbonate Hydrocarb “Grade 10160” (Omya Germany)

Particle size 2-3 μm

Calcium carbonate Omyacarb 2 GU (Omya Austria/Gummem)

Particle size 2 μm, PCC quality, moisture content 0.28%, whiteness 90.2%

Titanium dioxide “KRONOS 2050” (99% TiO2, rutile type, Kronos Germany)

Particle size 1.1-2.5 μm, whiteness >99.8% relative to barium sulfate standard

Titanium dioxide “TiPure 938” (99% TiO2, rutile type, DuPont Germany)

Particle size 1.1-2.5 μm, whiteness >99.6% relative to barium sulfate standard

Aquapel D 310 Alkyl Ketene Dimer (Hercules)

Sizing agent for paper based on alkyl ketene dimer resin and emulsifier, dry substance content around 13%

Alkyl succinyl anhydride ASA (Hercules)

Medium-viscous resin with 100% active substance

Lodyne 2000 fluorohydrocarbon FDA (Ciba)

Oily liquid, 100% active substance, FDA Approval, suitable for food contact

Oleophobol CO fluorohydrocarbon (Ciba)

Technical-grade fluorohydrocarbon, without FDA Approval

Tinofix AP Liquid cationization resin (Ciba England)

Additive for pigment fixation and printability

### Meaning or Explanation of the Technical Terms and Abbreviations Used:

### In the Abstract

[Micro-composites in this context are particles smaller than 500 μm, consisting of several phases, such as cellulose, lignin and starch].

### In the Specification of the Invention

[Schopper-Riegler grinding degree (° SR) is the drainage measurement of 1 liter of stock flow (fiber suspension) with 0.2% dry substance, per EN ISO 5267-1].

[Ground wood pulp is a TMP wood fiber produced by a wood grinder and generally being a soft wood long fiber].

[CTMP is bleached chemo-thermomechanical pulp, i.e., a bleached fiber substance, treated with chemicals at high temperature, and still containing a lot of lignin, unlike cellulose].

[Substance weight is the gram weight of the paper or cardboard, measured in g/m2].

[Retention agents, by forming bridges or by cationic charge together with fine inorganic substances, provide a high molar mass and prevent the washing out of very fine particles during the sheet formation, i.e., they retain these particles].

[“Fiber loading” is a special coating method that furnishes, for example, a coating layer of calcium carbonate on the fiber from an aqueous calcium hydroxide solution and carbon dioxide gas].

[“Mullen Burst” gives the bursting pressure [kPa] and the bursting index [kPa m2/g] in the dry state, according to Tappi method T 807; i.e., it is a measure of the mechanical strength of paper or cardboard].

[“Ply Bond” gives the internal ply strength [kPa], measured under tensile stress in the vertical direction, according to Tappi method UM 808].

[“Tensile Index” and “Tensile Breaking Strength” are the standardized tensile strengths, measured in percentage deflection using a force/distance sensor per unit of surface].

[The “tearing length” is a measure of the static tensile strength [km] under the natural weight of the sheet, similar to the maximum breaking load, but with constant deflection using Tappi method T 494 (DIN 53112)].

[Oxygen in the electronically excited singlet state acts as a bleaching agent in a peroxide bleach sequence much better than the oxygen of air in the triplet ground state].

[Enzymes like ligninases or cellubiohydrolases are advisable as pretreatment prior to the bleaching of lignocelluloses].

[“Wet strength agents” are required for paper types such as tissue, filter paper, label paper, currency and securities paper, and tea bag paper; the wet strength agent can be based on polyamidoamine-epichlorhydrin, melamine-formaldehyde or urea-formaldehyde].

[“Optical fluorescence brighteners” are all organic molecules that can absorb LW light and emit blue visible light].

[The “formation” is an esthetic evaluation of the uniformity of the sheet].

[“Nanodispersed cellulose” is a microcrystalline cellulose (MCC) with corresponding particle structure, sensitive to shear force].

[High “opacity” means little shine-through of the printed image for graphics paper; the measurement, in turn, is done as a reflection measurement at 457 nm, using a color meter].

[CSB is the chemical oxygen demand [ml/kg] in waste water].

[Flocculating agents, impurity traps, antislip additives and pigment fixing additives can each be assigned to different substance groups].

[Hydrophobicizing agents in the paper industry are, in particular, the alkylene ketene dimers (AKD), alkenyl ketene dimers, alkylsuccinic acid and its derivatives (ASA), hydrocarbon resins and colophony resins (rosin), fluorocarboxylic acids, polycarboxylic acids, fluororganyls, acid amides, fluorine-containing silanes, fluorosiloxanes, and also alums and aluminum sulfate for acid papers].

### In the Patent Claims:

[“Mullen mixer” is a discontinuous impeller mill, which subjects the material being ground to a friction, while at the same time fragmenting it.]

[“Nara Hybridizer” is an engineering college device from the Nara company for dry fragmentation processes, similar to an impeller mill].

[“SAE polymers” are styrene-acrylate copolymers, such as are used for paper sizing].

[LWC paper is a light-weight coated paper; substance weight under 26 pounds per 1000 square feet].

[Mat paper is a relatively abrasion-resistant coated or machine-coated mat printing paper].

[Satinized papers are papers coated with a finish ranging from silky mat to high gloss].

[SC paper (Supercalendered Paper) is a type of paper which is given a very homogeneous smooth surface by rollers].

[Newspaper printing paper is an opaque thin printing paper based on deinking agents, soft wood TMP, and recycling fibers, with around 2-28% ash].

[Tissue is a nonwoven material with a substance weight of around 8-35 g/m2].

[Testliner for corrugated cardboard and the like is made from recycling fiber and usually has a substance weight of 115-150 g/m2; it is used primarily for packaging].

[Fluting is likewise made primarily from recycling fiber, with special surface treatment].

[Size Press refers to the sizing process after sheet formation].

### IN SAMPLE EMBODIMENT 1

### Sizing Compound

[The “Cobb value 300” determines the amount of water taken up by a sized paper in a specific time frame (here: 300 seconds) under standard conditions, according to Tappi method T 441 and EN ISO 20535].

[The “drop test” is carried out by means of micropipette and determines the time till absorption of a particular amount of liquid, water or water-isopropanol mixture].

[Penetration tests per Tappi T 530 or Tappi 433 determine the time until a water layer breaks through a sized paper].

### IN SAMPLE EMBODIMENT 2

### Starch Compound

[The iodometric quantitative starch assay is done by titration with an iodine titration solution].

### IN SAMPLE EMBODIMENT 3

### Starch Compound [“OCC Furnish” is a special brown or gray stock flow from recycling folded-box cardboard (old corrugated containers), which can have fiber lengths of 3-4 mm]

[The “Rapid Köthen sheet former” is an engineering college device for making standardized laboratory sheets with diameter of 200 mm].

[The “Waring Blender” is a machine with fast-running rotor for mixing of liquids].

### IN SAMPLE EMBODIMENT 4

### Starch Compound

[“Dynamic Drainage Meter” from Mytec Co. is a precision measuring device to detect the drainage performance of fiber substances, without the forming of a precoat].

[“Asubstance” is an old paper substance of European grade A 12 or comparable grade].

[The SR screen is a mesh screen which is used for the Schopper-Riegler measurement].

### IN SAMPLE EMBODIMENT 5

### Mineral Compound

### IN SAMPLE EMBODIMENT 6

### Brightener Compound

[“Light Fastness” describes the Tappi test for light fastness].

1. Fiber-like or particle-like filler for paper, tissue and cardboard products, comprising at least one of cellulose, lignocellulose, or microcrystalline cellulose (MCC) which is intact or fragmented to small particle size and at least one additive, wherein the additive is coated or fixed to the surface of the cellulose component in solid, liquid, amorphous or microdispersed form.

2. Filler as set forth in claim 1, wherein the additive component(s) is/are basically coated or fixed to the surface of the cellulose fibers of the filler by thermo-mechanical forces, cross-linking, or drying.

3. Filler as set forth in claim 1, wherein the cellulose component comes from a raw material based on wood, cellulose (such as wood, straw, bamboo), microcrystalline cellulose (MCC), cotton, papermaking stock, reject stock, old paper, deinking paper, ground wood pulp, TMP, (B) CTMP or annual and perennial plants (such as chopped straw, soybean pods, oat husks, spelt, rice husks, ramie, sisal, bamboo, kenaf, flax, hemp, jute, prairie grass, kapok fiber, sugar beet pulp, Miscanthus).

4. Filler as set forth in claim 1, wherein the additive component(s), for their part, are already coated, surface-modified, compounded or microstructurized.

5. Filler as set forth in claim 1, wherein the particle sizes of the filler lie below 5 mm, preferably below 2000 μm and especially preferably below 400 μm.

6. Filler as set forth in claim 1, wherein the mass ratio of cellulose component to additive is at least 1/10, preferably at least 2/1.

7. Filler as set forth in claim 1, wherein the additives comprise minerals, fillers and/or pigments typical of the paper industry.

8. Filler as set forth in claim 1, wherein the additives comprise minerals and/or pigments in the form of kaolin, talc, titanium dioxide, fractured calcium carbonate (GCC), precipitated calcium carbonate (PCC), chalk, marble meal, silicate, silicic acid, barium sulfate, aluminum hydroxide, barium sulfide, barium titanate, corundum and/or zinc sulfide, which are also used as a water slurry in the presence of pregelatinized starch.

9. Filler as set forth in claim 1, wherein the additive comprises particulate or granular starch, modified starch, cationic starch or starch ethers, possibly in the form of a raw material or intermediate product containing the starch (fiber-starch microcompound), preferably making use of soft wheats (semolina, wood splitter dust, shredded wheat, Graham wheat, coarse-grained wheat flour, wheat feed meal, wheat leaf bran, feed wheat scraps) hard wheats (durum fine-ground meal, durum whole grain meal), oats (oat husk bran, rolled oat grain, oatmeal), rye (coarse rye meal, whole grain rye, rye bran, rolled rye grains, rye feed meal), barley (crushed barley grain, barley meal, feed barley), sprouted cereal meal, corn (cornmeal, corn scraps, corn semolina) or other starch-containing by-products (such as potato pulp, rice flakes, soy meal, rice bran, dinkel meal, buckwheat groats), as the raw material.

10. Filler as set forth in claim 9, wherein the particulate or granular starch comprises native or modified starch, based on potato, corn, waxy corn, wheat, triticale, barley, oats, rye, dinkel, buckwheat, rice, tapioca, sago and sorghum.

11. Filler as set forth in claim 1, wherein the additive comprises sizing agent (sizing additive).

12. Filler as set forth in claim 11, wherein the sizing agent comprises components such as alkyl ketene dimer (AKD), alkylsuccinic acid and its derivatives (ASA), colophony resin (rosin), fluorohydrocarbons, fluorinated carboxylic acids, polycarboxylic acids and acid amides, fluorine-containing silanes, and/or fluorosiloxanes, as well as additives such as sodium oleate, betulinol, tripalmitin, polyaluminum chloride, papermaking alum or resin dispersions (like styrene-acrylate, polyurethane dispersions), or also components for surface sizing, such as SAE polymers or polyurethane polymers.

13. Filler as set forth in claim 1, further comprising an optical brightener and it is present as a homogeneous cellulose or MCC microcompound or as nanodispersed filler for paper coating.

14. Filler as set forth in claim 13, further comprising a liquid or powder like brightener with aromatic and/or partially unsaturated aliphatic structure, for example, on the chemical basis of stilbene, azo-compounds, nitrogen heterocyclic compounds, sulfur compounds and the like; wherein the fibers used are possibly bleached in the presence of hydrogen peroxide, oxygen or ozone.

15. Filler as set forth in claim 1, further comprising a flame retardant.

16. Filler as set forth in claim 15, wherein the flame retardant comprises borate, boric acid, phosphate, phosphonate, triphenylphosphinoxide, polyoxazolidinone, bromoorganyls with antimony trioxide, polyunsaturated carbon resins, cashew nut shell liquid CNSL, and/or arachidonic acid.

17. Filler as set forth in claim 1, further comprising a biocide, and the biocide can be present in powder or liquid form, optionally together with thickeners, plant gums, carboxymethyl starch.

18. Filler as set forth in claim 17, wherein the biocide comprises an inorganic or organic boron compound, a nitrogen or sulfur compound.

19. Filler as set forth in claim 7, wherein said filler is a fiber light filler for paper, cardboard and tissue products, in which the filler has an elevated retention.

20. Filler as set forth in claim 7, wherein said filler is a fiber light filler for paper, cardboard and tissue products, for volume enhancement.

21. Filler as set forth in claim 9, to increase the starch retention.

22. Filler as set forth in claim 9, to increase the strength.

23. Filler as set forth in claim 11, to increase the sizing retention.

24. Filler as set forth in claim 11, to improve the hydrophobicity and/or oleophobicity.

25. Filler as set forth in claim 11, to increase the stability during the sizing.

26. Filler as set forth in claim 1, further comprising an antistatic additive, especially an electrically conductive substrate.

27. Filler as set forth in claim 26 to improve the conductivity of paper and cardboard products, also in the form of a lamination.

28. Filler as set forth in claim 1, further comprising further additive components such as binders, wet strength agents, cationized guar, xanthane derivatives, polyimines, polyvinylamines, flocculating agents, nanoparticle systems, impurity binders, polymers, antislip additives, additive for pigment fixation, brighteners, defoamers or preservatives.

29. Filler as set forth in claim 28, provided in the form of a granulate, microgranulate, pelletized granulate, pellet, compactate, molded body, press bar or press ball, which can also be redispersable.

30. Filler as set forth in claim 1, for use in the field of pulp cardboard, recycling cardboard, packaging papers, food cardboard, eating trays, packing trays, LWC paper, coated base paper, LWC roller offset, graphic papers, mat paper, calendered and satinized papers, SC papers, corrugated cardboard base paper, newspaper print papers, nonwovens and tissue, testliner and fluting.

31. Filler as set forth in claim 1, also as a granulate, for use in paper coating, for coating of paper or cardboard with the usual coating method.

32. Filler as set forth in claim 1, also as a low-dust granulate, further comprising fillers such as natural calcium carbonate (GCC), precipitated calcium carbonate (PCC), kaolin (aluminum silicate), calcined kaolins, talc (magnesium silicate), marble meal, limestone meal, chalk, as well as pigments like titanium dioxide, barium sulfate, barium titanate, zinc sulfide, corundum, as well as starch-containing products (native starch, cooking starch, cold water-soluble starch, extruded or pregelatinized starch, cationized starch) based on wheat, corn, potato, tapioca, rice or amaranth, as well as aluminum salts, alums and binders like latex, or sizing agents like caseinates, as additive.

33. Filler as set forth in claim 1, wherein the cellulose component or the filler is cationized or contains additives (like cationized starch, cationized regenerate fibers, cationized lignocellulose, polyimine, urea-glyoxal reaction products), which change the zeta potential.

34. Filler as set forth in claim 1, further comprising wet strength agents such as urea-formaldehyde resin or polyamidamine-epichlorhydrin resins, ketene derivatives, or diketenes.

35. Filler as set forth in claim 1, further comprising hydrophobicizing agents (like calcium stearate, magnesium stearate, zinc stearate, silicone-vinyl resins, montan-wax or carnauba wax, fluororganic components) or ultrafine colloids.

36. Filler as set forth in claim 1, wherein the additive comprises a flame retardant, such as phosphate salts, borate salts, micro-encapsulated phosphonates), carboxymethyl cellulose, starch (also modified starch and derivatives), preservatives.

37. Filler as set forth in claim 1, wherein the cellulose fiber used comprises primarily cellulose derivatives or regenerate celluloses.

38. The filler of claim 1, provided as part of a dry mixture of paper additives or flow adjuvants.

39. Method for making a filler with at least one cellulose component and at least one additive component as set forth in claim 1, wherein mechanical, especially thermomechanical energy is introduced into a mixture of the cellulose component with the additive component in order to fix or coat the at least one additive on the surface of the cellulose component or to make a homogeneous compound from the cellulose component and the additive component, taking into account an adequately long treatment time.

40. The method as set forth in claim 39, wherein the mechanical or thermo-mechanical energy is introduced in such a way that the mixture is subjected to pressure and internal friction within the mixture.

41. The method as set forth in claim 39 or 40, wherein, to produce fiber compounds with mineral and/or pigment additives, one uses a device from the group of roller mill, roll compactor, cylinder mill, Kahl press, RIM (rotor inertia mill), hybridizer, gyratory mill, impeller mill, Mullen mixer, disk vibration mill, extruder, extrusion press, vertical kneader, co-kneader.

42. the method as set forth in claim 39 to produce fiber compounds with starch, modified starch, cationic starch or starch ethane wherein the starch is preferably partly pre-gelatinized by introducing thermo-mechanical energy.

43. The method as set forth in claim 39 wherein, to produce fiber compounds with starch, modified starch, cationic starch or starch ethane, one uses a device from the group of roll mill, roll compactor, cylinder mill, Kahl press, RIM (rotor inertia mill), hybridizer, gyratory mill, impeller mill, Mullen mixer, disk vibration mill, extruder, extrusion press, vertical kneader, co-kneader, or the like.

44. The method as set forth in claim 39 wherein, to produce fiber compounds with sizing additive, dry cellulose fibers are treated with at least one liquid sizing additive in a mixer, an intensive mixer, a rotor mill, a sifter mill, in order to fix or to coat the sizing agent on the surface.

45. The method as set forth in claim 39, for producing of fiber compounds with optical brightener, wherein the cellulose or microcrystalline cellulose (MCC) is reacted with a liquid optical brightener by means of mixer, rotor mill, turbo-mill, impact crusher, pinned disk mill or sifter mill.

46. The method as set forth in claim 39, for producing of fiber compounds with flame retardant wherein the cellulose component is reacted with a liquid, water-dilutable or emulsifiable flame retardant by means of a baker's paddle mixer, plowshare mixer, rotor mill, turbo-mill, impact crusher, pinned disk mill or sifter mill.

47. the method as set forth in claim 39, for producing of fiber compounds with biocidal coating wherein the cellulose component is reacted with a liquid, water-dilutable or emulsifiable biocide by means of a baker's paddle mixer, plowshare mixer, rotor mill, turbo-mill, impact crusher, pinned disk mill or sifter mill.

48. The method as set forth in claim 39, for producing of fiber compounds with antistatic additive wherein dry fibers are reacted with at least one liquid conductive resin or one conductive substrate or one conductive pigment paste.

49. The method as set forth in claim 39 comprising processing of the fiber substance through granulating rolls (with and without friction, with and without fluting, with and without cam crusher), roll compactor (with and without friction), briquetting system, bar press, flat-die or round-die pelleting press, calendering layout, tabletting machine, double and multiple-roll granulator, fluidized bed granulator, granulating mill, beater screen machine, granulate rubbing (rubbing comminuting) machines, press table, transfer press, extruder, co-kneader, traveling screen press or extrusion press.

50. The method as set forth in claim 39 wherein the components of the mixture for the paper coating are processed on a size press as pumpable formulation, especially in the presence of calcium carbonate, kaolin, binder, brightener, pigment, carboxymethyl cellulose (CMC), casein, low-molecular polyvinyl alcohols or soluble starch or other components as are typical of coating formulas.

51. The method as set forth in claim 39 wherein the components of the mixture, especially for roll application with doctor blade or Mayer Barr, contains thickening and/or theological adjuvants, such as carboxymethyl cellulose (CMC), xanthane, cellulose gel.

52. The filler of claim 1, provided as part of a paper, tissue or cardboard product.

53. The filler of claim 2, provided as part of a dry mixture of paper additives or flow adjuvants.

54. The filler of claim 3, provided as part of a dry mixture of paper additives or flow adjuvants.

55. The filler of claim 4, provided as part of a dry mixture of paper additives or flow adjuvants.

56. The filler of claim 5, provided as part of a dry mixture of paper additives or flow adjuvants.
